(19) United States
(12) Patent Application Publication
(10) Pub. No.: US 2010/0209319 A1
(43) Pub. Date: Aug. 19, 2010

(54) DEVICE FOR PRODUCING A CRYSTALLIZED SILICON BODY FOR SOLAR CELLS

(75) Inventor: In Seok CHOI, Mapo-ku (KR)

Correspondence Address: JORDAN AND HAMBURG LLP, 122 EAST 42ND STREET, SUITE 4000, NEW YORK, NY, 10168, US

(73) Assignee: THERMVAC ENGINEERING INC., Seongnam-si (KR)

(21) Appl. No.: 12/629,997

(22) Filed: Dec. 3, 2009

(30) Foreign Application Priority Data
Feb. 17, 2009 (KR) 10-2009-0012979

(51) Int. Cl. B01D 9/00

(52) U.S. Cl. 422/245.1

(57) ABSTRACT

A device is provided for producing a crystallized silicon body for solar cells. The device includes a reaction vessel, a silicon container arranged within the reaction vessel for containing a raw silicon material, an upper heater arranged above the silicon container for heating the raw silicon material contained in the silicon container, a lower heater arranged below the silicon container for heating the raw silicon material contained in the silicon container, and an insulator unit arranged inside the reaction vessel for surrounding the silicon container, the upper heater and the lower heater. The insulator unit is provided with a side insulator which includes a fixed side insulation member, a plurality of movable side insulation members coupled with the fixed side insulation member and a plurality of side actuators operatively connected to the movable side insulation members for moving the movable side insulation members toward or away from the silicon container.

### FIELD OF THE INVENTION

The present invention relates to a device for producing a crystallized silicon body for solar cells and, more particularly, to a device for the production of a crystallized silicon body capable of releasing thermal insulation in a melting step to maximize the heat transfer rate and increase the melting efficiency, insulating the side surface of a silicon container but releasing thermal insulation of the lower portion of the silicon container in a crystallization step to perform cooling in one direction, and opening the insulation space at the end of crystallization to shorten the cooling time and advance the next production cycle.

### BACKGROUND OF THE INVENTION

In general, a polycrystalline silicon ingot for solar cells is produced by filling a raw silicon material in a quartz or graphite furnace, melting the silicon material into a silicon liquid and directionally solidifying the silicon liquid into a polycrystalline silicon ingot. As the demand for solar cells soars up by several ten percents per year, the demand for polycrystalline silicon ingots used in producing the solar cells is also sharply increased in recent years.

JP Patent Application No. 11-101706 discloses one typical example of the conventional polycrystalline silicon production devices, which is shown in FIG. 1.

Referring to FIG. 1, the polycrystalline silicon production device 1 includes a reaction vessel 2 with dual walls 2a defining therebetween a coolant passage through which to circulate coolant, a silicon container 4 arranged within the reaction vessel 2 for containing a raw silicon material 3a therein, a cooling plate 5 arranged below the silicon container 4 and supplied with coolant from outside the reaction vessel 2 for cooling a silicon liquid 3 contained in the silicon container 4, a surrounding unit 6 provided with a plurality of insulation members for surrounding the silicon container 4 and the cooling plate 5, a container insulating member 4a for surrounding the periphery of the silicon container 4 to thermally insulate the silicon container 4, an upper heater 7a arranged above the silicon container 4 within the surrounding unit 6 for heating the raw silicon material 3a put in the silicon container 4, a lower heater 7b arranged below the silicon container 4 within the surrounding unit 6 for heating the raw silicon material 3a put in the silicon container 4, a gas inlet port 8 through which to introduce an inert gas into the reaction vessel 2, an insulation member moving unit 9 for moving a movable insulation member 6a which forms a part of the surrounding unit 6, and a partition member 6d arranged around the cooling plate 5 for dividing the internal space of the surrounding unit 6 into an upper space 6b and a lower space 6c.

With the polycrystalline silicon production device 1 configured as above, a raw silicon material 3a is put in the silicon container 4 and heated into a silicon liquid 3 with the upper heater 7a and the lower heater 7b. Then, the silicon liquid 3 is cooled and crystallized by moving the movable insulation member 6a away from the surrounding unit 6, introducing a cold inert gas into the lower space 6c and circulating coolant through the cooling plate 5. This makes it possible to cool the silicon container 4 and the silicon liquid 3 at an increased cooling speed.

In the conventional device, however, the container insulation member is fixed in one position so as to permanently insulate the silicon container. During the course of heating the raw silicon material, the heat of the upper heater is shielded by the insulation member and cannot be transferred to the side surface of the silicon container. This reduces the melting speed of the raw silicon material.

Moreover, the conventional device is structurally complicated and difficult to operate because the coolant needs to be supplied to the cooling plate with a specially-designed coolant supply unit.

Since only the bottom portion of the silicon container is cooled after crystallization has been completed, the conventional device suffers from reduction in cooling speed and requires a long period of waiting time for the next production cycle to be started. This leads to reduced productivity.

Under these circumstances, an acute demand has existed for a device for producing a crystallized silicon body for solar cells that can enhance the melting efficiency by increasing the heat transfer area and can also shorten the waiting time for the next production cycle by rapidly cooling the silicon liquid at the end of the crystallization step.

### SUMMARY OF THE INVENTION

In view of the above-noted and other problems inherent in the prior art, it is an object of the present invention to provide a device for producing a crystallized silicon body for solar cells capable of releasing thermal insulation in a melting step to increase the melting efficiency, performing thermal insulation in a crystallization step and opening an insulated space after the crystallization step to rapidly perform a cooling step.

Another object of the present invention is to provide a device for producing a crystallized silicon body for solar cells that can use a part of a side insulation member as a container insulation member, thereby eliminating the need to employ an additional insulation member for insulation of the side surface of a silicon container otherwise required to assure unidirectional growth of silicon crystals.

A further object of the present invention is to provide a device for producing a crystallized silicon body for solar cells capable of opening an insulated space at the end of silicon crystal growth, thereby rapidly cooling a silicon container and quickly proceeding to the next production cycle.

A still further object of the present invention is to provide a device for producing a crystallized silicon body for solar cells, in which a movable insulation member for insulating the side surface of a silicon container is supported by a table during its movement, thereby making it possible to prevent deflection or deformation of the movable insulation member.

In accordance with the present invention, there is provided a device for producing a crystallized silicon body for solar cells, including: a reaction vessel; a silicon container arranged within the reaction vessel for containing a raw silicon material therein; an upper heater arranged above the silicon container for heating the raw silicon material contained in the silicon container; a lower heater arranged below the silicon container for heating the raw silicon material contained in the silicon container; and an insulator unit arranged inside the reaction vessel for surrounding the silicon container, the upper heater and the lower heater, wherein the insulator unit includes a side insulator with top and bottom openings, an upper insulator attached to the top opening of the side insulator and a lower insulator attached to the bottom opening of the side insulator, and wherein the side insulator includes a fixed side insulation member, a plurality of movable side insulation members coupled with the fixed side insulation member for movement with respect to the silicon container and a plurality of side actuators operatively connected to the movable side insulation members for moving the movable side insulation members toward or away from the silicon container.

In the device set forth above, the upper insulator may include a fixed upper insulation member with an aperture, a movable upper insulation member fitted to the aperture of the fixed upper insulation member and an upper actuator for moving the movable upper insulation member with respect to the fixed upper insulation member to open and close the aperture of the fixed upper insulation member.

In the device set forth above, the lower insulator may include a fixed lower insulation member with an aperture, a movable lower insulation member fitted to the aperture of the fixed lower insulation member and a lower actuator for moving the movable lower insulation member with respect to the fixed lower insulation member to open and close the aperture of the fixed lower insulation member.

The device set forth above may further include a table for supporting the silicon container, the table being arranged to support the movable side insulation members of the side insulator when the movable side insulation members are moved toward or away from the silicon container.

In the device set forth above, the insulator unit may have an internal insulated space defined by the side insulator, the upper insulator and the lower insulator, and the internal insulated space may be divided by the table into an upper insulation space for accommodating the silicon container and the upper heater and a lower insulation space for accommodating the lower heater.

With the present invention configured as above, there is provided an advantageous effect in that the device is capable of releasing thermal insulation in a melting step to increase the melting efficiency, performing thermal insulation in a crystallization step and opening an insulated space after the crystallization step to rapidly perform a cooling step.

Another advantageous effect of the present invention lies in that the device for producing a crystallized silicon body for solar cells can use a part of a side insulation member as a container insulation member, thereby eliminating the need to employ an additional insulation member for insulation of the side surface of a silicon container otherwise required to assure unidirectional growth of silicon crystals.

A further advantageous effect of the present invention resides in that the device for producing a crystallized silicon body for solar cells is capable of opening an insulated space at the end of silicon crystal growth, thereby rapidly cooling a silicon container and quickly proceeding to the next production cycle.

A still further advantageous effect of the present invention lies in that the movable insulation member for insulating the side surface of a silicon container is supported by a table during its movement, thereby making it possible to prevent deflection or deformation of the movable insulation member.

### BRIEF DESCRIPTION OF THE DRAWINGS

The above and other objects and features of the present invention will become apparent from the following description of preferred embodiments, given in conjunction with the accompanying drawings, in which:

FIG. 1 is a vertical section view illustrating a conventional crystallized silicon body production device;

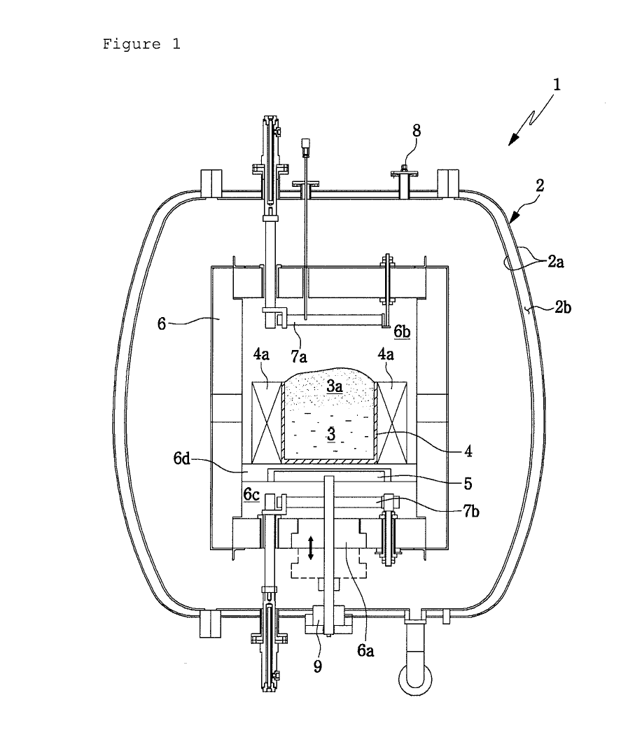

FIG. 2 is a vertical section view showing a device for producing a crystallized silicon body for solar cells in accordance with the present invention;

FIG. 3 is a vertical section view of the present device depicting a melting operation by which to melt a raw silicon material of solid state;

FIG. 4 is a vertical section view of the present device depicting a chilling operation by which to crystallize a silicon liquid;

FIG. 5 is a vertical section view of the present device depicting a rapid cooling operation by which to rapidly cool a crystallized silicon body; and

FIG. 6 is a graph representing the correlation between the temperature and the time in the process of producing a crystallized silicon body.

### DETAILED DESCRIPTION OF THE PREFERRED EMBODIMENTS

One preferred embodiment of the present invention will now be described in detail with reference to the accompanying drawings.

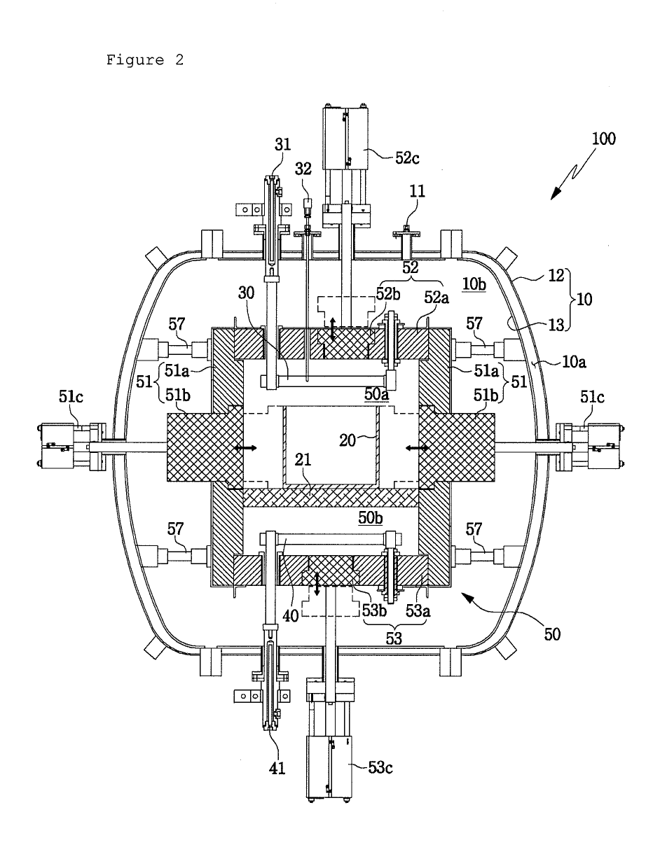

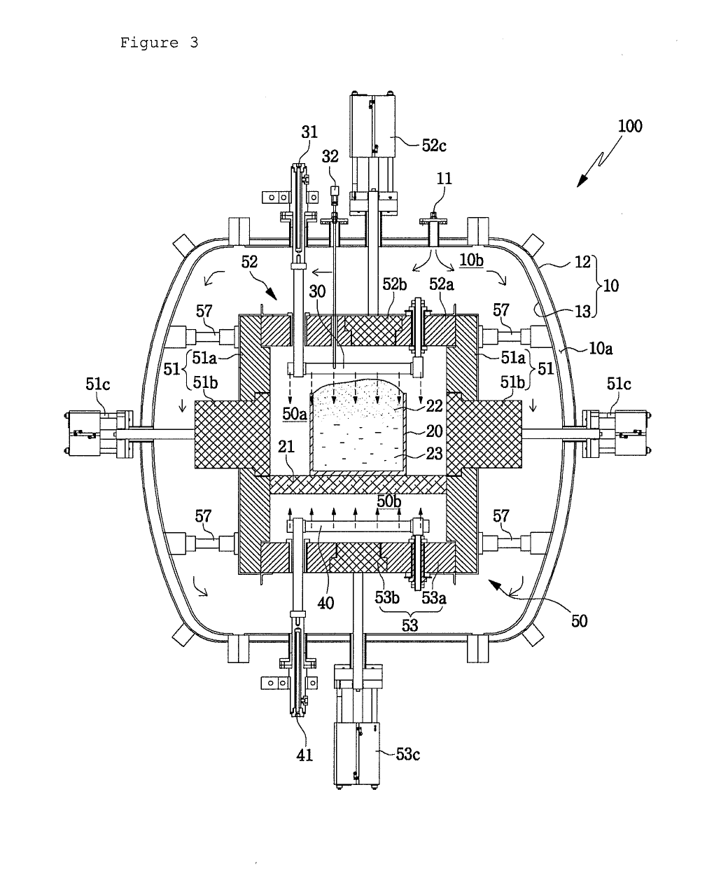

Referring first to FIGS. 2 and 3, the device 100 for producing a crystallized silicon body for solar cells in accordance with the present invention includes a reaction vessel 10 with a gas inlet port 11 through which to introduce an inert gas into the reaction vessel 10, a silicon container 20 arranged within the reaction vessel 10 for containing a raw silicon material 22 therein, a table 21 for supporting the silicon container 20 placed thereon, an upper heater 30 arranged above the silicon container 20 for heating the raw silicon material 22 contained in the silicon container 20, a lower heater 40 arranged below the silicon container 20 for heating the raw silicon material contained in the silicon container 20, and an insulator unit 50 arranged inside the reaction vessel 10 for surrounding the silicon container 20, the upper heater 30 and the lower heater 40.

The insulator unit 50 includes a side insulator 51 with top and bottom openings, an upper insulator 52 attached to the top opening of the side insulator 51 and a lower insulator 53 attached to the bottom opening of the side insulator 51. The side insulator 51, the upper insulator 52 and the lower insulator 53 cooperate to define an insulated space therebetween. The table 21 is arranged within the insulator unit 50 so that it can support the silicon container 20.

The side insulator 51 includes a fixed side insulation member 51a of, e.g., generally rectangular tube shape, a plurality of movable side insulation members 51b coupled with the fixed side insulation member 51a and a plurality of side actuators 51c operatively connected to the movable side insulation members 51b for horizontally moving the movable side insulation members 51b toward or away from the silicon container 20. During their movement, the movable side insulation members 51b are supported by and slid along the table 21.

The upper insulator 52 includes a fixed upper insulation member 52a with an aperture, a movable upper insulation member 52b fitted to the aperture of the fixed upper insulation member 52a and an upper actuator 52c for vertically moving the movable upper insulation member 52b with respect to the fixed upper insulation member 52a to open and close the aperture of the fixed upper insulation member 52a.

Similarly, the lower insulator 53 includes a fixed lower insulation member 53a with an aperture, a movable lower insulation member 53b fitted to the aperture of the fixed lower insulation member 53a and a lower actuator 53c for vertically moving the movable lower insulation member 53b with respect to the fixed lower insulation member 53a to open and close the aperture of the fixed lower insulation member 53a. The side actuators 51c, the upper actuator 52c and the lower actuator 53c may be formed of, e.g., air cylinders.

The reaction vessel 10 includes an outer wall 12 and an inner wall 13, both of which spaced apart from each other to define a coolant flow path 10a. A coolant is allowed to flow through the coolant flow path 10a. The fixed side insulation member 51a of the side insulator 51 is connected to the inner wall 13 of the reaction vessel 10 by a plurality of connectors 57.

The silicon container 20 serves as a reservoir for containing a silicon liquid 22 obtained by melting the raw silicon material 22. The upper heater 30 and the lower heater 40 are arranged in the insulated space in such a fashion as to efficiently heat the silicon container 20. An upper electrode 31 extending through the walls 12 and 13 of the reaction vessel 10 the upper insulator 52 of the insulator unit 50 is connected to the upper heater 30. Likewise, a lower electrode 41 extending through the walls 12 and 13 of the reaction vessel 10 and the lower insulator 53 of the insulator unit 50 is connected to the lower heater 40. A thermocouple 32 for sensing the temperature of the upper heater 30 is connected to the upper heater 30.

The insulated space of the insulator unit 50 is divided by the table 21 into an upper insulation space 50a for accommodating the upper heater 30 and the silicon container 20 and a lower insulation space 50b for accommodating the lower heater 40.

In a melting step in which the raw silicon material 22 is melted into a silicon liquid 23, the movable side insulation members 51b of the side insulator 51 remain moved away from the silicon container 20, while the movable upper insulation member 52b of the upper insulator 52 and the movable lower insulation member 53b of the lower insulator 53 are kept coupled with the fixed upper insulation member 52a and the fixed lower insulation member 53a. In a crystallization step in which the silicon liquid 23 is subjected to crystal growth, the movable side insulation members 51b are moved toward the silicon container 20 to make contact with the side surface thereof and the movable lower insulation member 53b is moved away from the fixed lower insulation member 53a to open the lower insulation space 50b, thus allowing the silicon liquid 23 to be solidified in one direction. At the end of the crystallization step, the movable side insulation members 51b are moved away from the silicon container 20 to release thermal insulation thereof and the movable upper insulation member 52b is moved away from the fixed upper insulation member 52a to open the upper insulation space 50a, thereby allowing the silicon container 20 to be rapidly cooled.

Next, the operation of the present device 100 will be described in more detail.

A door (not shown) of the reaction vessel 10 is opened and a raw silicon material 22 is put in the silicon container 20 placed on the table 21 as illustrated in FIG. 3. The door is closed and the air present within the reaction vessel 10 is discharged by a vacuum pump (not shown) to evacuate the reaction vessel 10 into a vacuum state. An inert gas is introduced into the reaction vessel 10 through the gas inlet port 11 of the reaction vessel 10.

Then, the upper heater 30 and the lower heater 40 are energized to heat the upper insulation space 50a and the lower insulation space 50b. The heating temperature is set a little higher than 1410° C. at which the raw silicon material 22 begins to melt. The raw silicon material 22 contained in the silicon container 20 is completely melted at this heating temperature. The upper heater 30 directly heats the upper portion of the silicon container 20, while the lower heater 40 indirectly heats the bottom portion of the silicon container 20 through the table 21.

At this time, the side actuators 51c are operated to move the movable side insulation members 51b away from the silicon container 20, thereby releasing thermal insulation of the side surface of the silicon container 20 so that the heat can be directly transferred to the side surface of the silicon container 20. The movable upper insulation member 52b and the movable lower insulation member 53b are kept coupled with the apertures of the fixed upper insulation member 52a and the fixed lower insulation member 53a, thereby closing the upper insulation space 50a and the lower insulation space 50b. As the heating operation is performed, the raw silicon material 22 is melted into a silicon liquid 23.

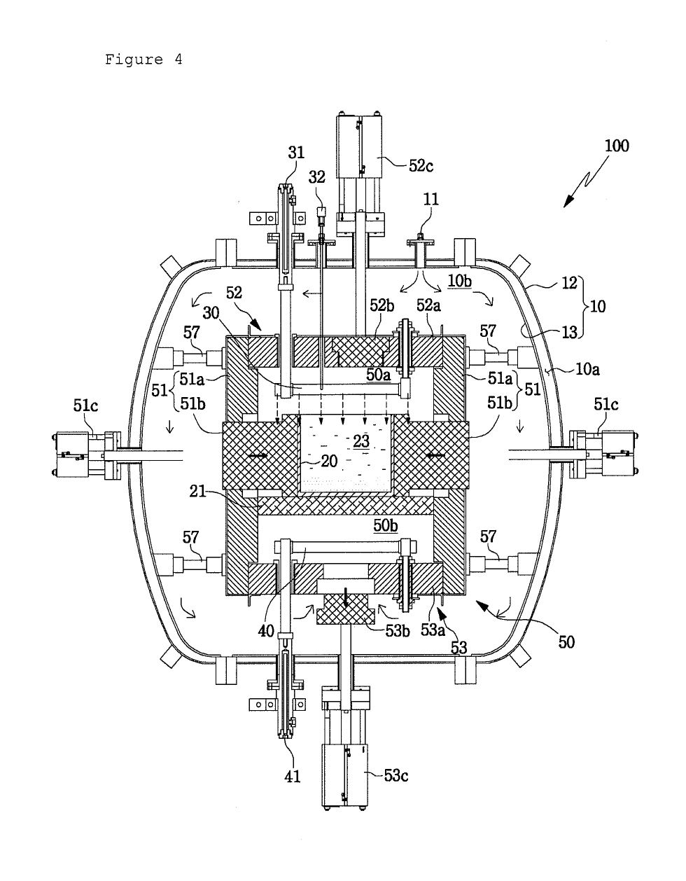

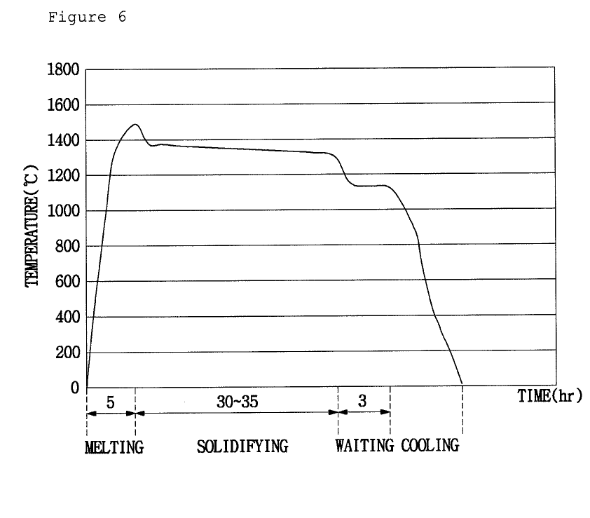

Once the silicon liquid 23 is obtained by the heating operation as illustrated in FIGS. 4 and 6, the lower heater 40 is turned off while keeping the upper heater 30 turned on. The side actuators 51c are operated to move the movable side insulation members 51b toward the silicon container 20, whereby the side surface of the silicon container 20 is thermally insulated by the movable side insulation members 51b. Simultaneously, the lower actuator 53c is operated to move the movable lower insulation member 53b away from the fixed lower insulation member 53a so that the internal space 10b of the reaction vessel 10 can communicate with the lower insulation space 50b through the aperture of the fixed lower insulation member 53a. Thus, the inert gas cooled by the coolant circulating through the coolant flow path 10a is introduced into the lower insulation space 50b to gradually cool the bottom portion of the silicon container 20 containing the silicon liquid 23. By regulating the heat generation quantity of the upper heater 30 and the opening degree of the movable lower insulation member 53b, the cooling speed of the silicon liquid 23 is controlled in such a way that the silicon liquid 23 is gradually solidified from the bottom thereof while keeping the upper portion of the silicon liquid 23 melted.

The movable side insulation members 51b serve to prevent the heat from being radiated from or applied to the side surface of the silicon container 20, so that no horizontal temperature gradient occurs within the silicon container 20. In a hypothetical case that the side surface of the silicon container 20 has a higher temperature than the center thereof, the crystal growth direction or the impurity density may become irregular. This may reduce the quality of a crystallized silicon body and the yield rate thereof.

After the silicon liquid 23 has been solidified into a crystallized silicon body 24 by controlling the cooling speed of the silicon liquid 23, namely the heat generation quantity of the upper heater 30 and the opening degree of the movable lower insulation member 53b, the crystallized silicon body 24 is subjected to annealing at about 1200° C. to remove thermal stresses remaining therein.

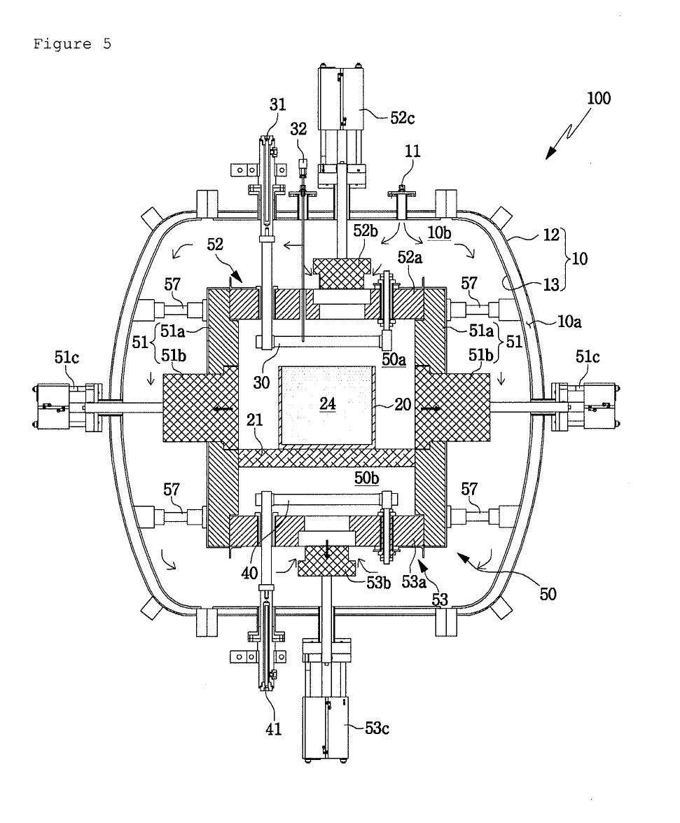

At the end of the annealing step, the upper heater 30 is turned off and the movable side insulation members 51b are moved away from the silicon container 20 as illustrated in FIGS. 5 and 6. Simultaneously, the upper actuator 52c is operated to move the movable upper insulation member 52b away from the fixed upper insulation member 52a to open the aperture of the latter. As a result, the inert gas cooled by the coolant circulating through the coolant flow path 10a is introduced into the upper insulation space 50a to rapidly cool the silicon container 20 and the crystallized silicon body 24 contained therein. At this time, the movable lower insulation member 53b is kept opened.

If the silicon container 20 and the reaction vessel 10 are sufficiently cooled, the movable upper insulation member 52b and the movable lower insulation member 53b are moved into the original positions to close the upper insulation space 50a and the lower insulation space 50b. Thereafter, the door of the reaction vessel 10 is opened to take out the crystallized silicon body 24, thereby terminating the production cycle of the crystallized silicon body 24.

As described above, the movable side insulation members 51b are supported by and moved along the table 21 when they are moved toward or away from the silicon container 20. This reduces the load to be borne by the side actuators 51c and prevents the cylinder rods of the side actuators 51c from being deflected or deformed. Thus, the side actuators 51c can be operated in a structurally stable state.

In the melting step for melting the raw silicon material 22, the movable side insulation members 51b are moved away from the silicon container 20 so that the heat of the upper heater 30 and the lower heater 40 can be applied to the side surface of the silicon container 20. This assists in increasing the melting efficiency.

In the crystallization step for crystallizing the silicon liquid 23, the movable side insulation members 51b are brought into contact with the side surface of the silicon container 20 to thereby minimize the horizontal temperature gradient. Furthermore, the movable lower insulation member 53b is moved away from the fixed upper insulation member 52a to open the lower insulation space 50b. Then, the cold inert gas filled in the internal space 10b of the reaction vessel 10 is introduced into the lower insulation space 50b to assure unilateral growth of silicon crystals. This makes it possible to produce the crystallized silicon body 24 with high quality and increased yield rate.

At the end of the crystallization step, the movable side insulation members 51b are moved away from the silicon container 20 and the movable upper insulation member 52b is moved away from the fixed upper insulation member 52a to allow the upper insulation space 50a to communicate with the internal space 10b of the reaction vessel 10. Thus, the cold inert gas is introduced into the upper insulation space 50a to rapidly cool the silicon container 20 and the crystallized silicon body 24. At this time, the movable lower insulation member 53b is kept moved away from the fixed lower insulation member 53a so that the lower insulation space 50b can communicate with the internal space 10b of the reaction vessel 10. This reduces the time required in proceeding to the next production cycle.

By employing the movable side insulation members 51b, the movable upper insulation member 52b and the movable lower insulation member 53b, it becomes possible to increase the melting speed and the cooling speed while assuring unilateral growth of silicon crystals. This helps drastically increase the productivity of the crystallized silicon body 24.

While certain embodiments of the present invention have been described hereinabove, the present invention shall not be limited thereto. It will be understood by those skilled in the art that various changes and modifications may be made without departing from the scope of the invention defined in the claims.

What is claimed is:

1. A device for producing a crystallized silicon body for solar cells, comprising:
a reaction vessel;
a silicon container arranged within the reaction vessel for containing a raw silicon material therein;
an upper heater arranged above the silicon container for heating the raw silicon material contained in the silicon container;
a lower heater arranged below the silicon container for heating the raw silicon material contained in the silicon container; and
an insulator unit arranged inside the reaction vessel for surrounding the silicon container, the upper heater and the lower heater,
wherein the insulator unit includes a side insulator with top and bottom openings, an upper insulator attached to the top opening of the side insulator and a lower insulator attached to the bottom opening of the side insulator, and wherein the side insulator includes a fixed side insulation member, a plurality of movable side insulation members coupled with the fixed side insulation member for movement with respect to the silicon container and a plurality of side actuators operatively connected to the movable side insulation members for moving the movable side insulation members toward or away from the silicon container.

2. The device as recited in claim 1, wherein the upper insulator includes a fixed upper insulation member with an aperture, a movable upper insulation member fitted to the aperture of the fixed upper insulation member and an upper actuator for moving the movable upper insulation member with respect to the fixed upper insulation member to open and close the aperture of the fixed upper insulation member.

3. The device as recited in claim 2, wherein the lower insulator includes a fixed lower insulation member with an aperture, a movable lower insulation member fitted to the aperture of the fixed lower insulation member and a lower actuator for moving the movable lower insulation member with respect to the fixed lower insulation member to open and close the aperture of the fixed lower insulation member.

4. The device as recited in claim 1, further comprising a table for supporting the silicon container, the table being arranged to support the movable side insulation members of the side insulator when the movable side insulation members are moved toward or away from the silicon container.

5. The device as recited in claim 4, wherein the insulator unit has an internal insulated space defined by the side insulator, the upper insulator and the lower insulator, and wherein the internal insulated space is divided by the table into an upper insulation space for accommodating the silicon container and the upper heater and a lower insulation space for accommodating the lower heater.
